(19) United States
(12) Patent Application Publication
(10) Pub. No.: US 2024/0275769 A1
(43) Pub. Date: Aug. 15, 2024

(54) MANAGING AN ENCRYPTED CONNECTION WITH A CLOUD SERVICE PROVIDER

(71) Applicant: Oracle International Corporation, Redwood Shores, CA (US)

(72) Inventors: Peter John Hill, Seattle, WA (US); Jagannadha Rao Tamvada, Union City, CA (US); Mikhail Dmitriyevich Kasvin, Seattle, WA (US)

(21) Appl. No.: 18/109,208

(22) Filed: Feb. 13, 2023

(51) Int. Cl. H04L 9/40

(52) U.S. Cl. CPC H04L 63/0485; H04L 63/029

(57) ABSTRACT

According to certain implementations, a cloud service provider infrastructure establishes a communication tunnel between an on-premise tunnel endpoint within a customer on-premise environment and a cloud-side tunnel endpoint within the cloud service provider infrastructure. One or more components of the cloud service provider infrastructure monitor this communication tunnel and determine, based on the monitoring, updates to one or more parameters used to implement the communication tunnel at the on-premise tunnel endpoint within the customer on-premise environment. These updates are sent from the cloud service provider infrastructure to an agent installed within the customer on-premise environment, and the agent implements the updates at the on-premise tunnel endpoint. This enables the automatic updating of the on-premise tunnel endpoint by the cloud service provider infrastructure.

### BACKGROUND

Many organizations are moving applications and workloads to the cloud. The move enables IT to quickly scale resources based on actual need and provides consolidated management of infrastructure at a global level. An effective way to utilize a cloud service provider's resources is to connect a customer's on-premise environment (such as a datacenter) to the cloud service provider infrastructure. This may be performed by the customer selecting an edge device in their on-premise network and communicating with a router in the cloud environment to establish a communication channel from the edge device to the cloud environment.

The process of establishing the communication channel includes the customer configuring parameters of the communication channel in a manual fashion. The cloud environment typically has no control over the edge device and/or configuration settings associated with establishing the communication channel(s). As such, the process of extending the on-premise network of the customer to the cloud environment is a tedious process involving a high degree of customer intervention.

### BRIEF SUMMARY

The present disclosure relates generally to encrypted connection management. More particularly, novel techniques are described for managing an encrypted connection between a customer on-premise environment and a cloud service provider infrastructure. Various embodiments are described herein to illustrate various features. These embodiments include various methods, systems, non-transitory computer-readable storage media storing programs, code, or instructions executable by one or more processors, and the like.

According to certain implementations, a cloud service provider infrastructure establishes a communication tunnel between an on-premise tunnel endpoint within a customer on-premise environment and a cloud-side tunnel endpoint within the cloud service provider infrastructure. One or more components of the cloud service provider infrastructure monitor this communication tunnel and determine, based on the monitoring, updates to one or more parameters used to implement the communication tunnel at the on-premise tunnel endpoint within the customer on-premise environment. These updates are sent from the cloud service provider infrastructure to an agent installed within the customer on-premise environment, and the agent implements the updates at the on-premise tunnel endpoint. This enables the automatic updating of the on-premise tunnel endpoint by the cloud service provider infrastructure.

At least one embodiment is directed to a computer-implemented method. The method can include monitoring, by a computer system within a cloud service provider infrastructure, a communication tunnel established between an on-premise tunnel endpoint within a customer on-premise environment and a cloud-side tunnel endpoint within the cloud service provider infrastructure; determining, by the computer system within the cloud service provider infrastructure, updates to one or more parameters used by the on-premise tunnel endpoint to implement the communication tunnel; and transmitting, by the computer system within the cloud service provider infrastructure to an agent implemented within the customer on-premise environment, one or more instructions to be implemented by the agent to update the one or more parameters used by the on-premise tunnel endpoint to implement the communication tunnel.

Another embodiment is directed to a system comprising one or more processors and instructions that, when executed by the one or more processors, cause the computing device to perform any suitable combination of the method(s) disclosed herein.

Still another embodiment is directed to a non-transitory computer-readable medium storing computer-executable instructions that, when executed by one or more processors of a computing cluster, cause the computing cluster to perform any suitable combination of the method(s) disclosed herein.

The foregoing, together with other features and embodiments will become more apparent upon referring to the following specification, claims, and accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an exemplary managed communication tunnel environment, according to at least one embodiment.

FIG. 2 illustrates an example method for updating on-premise tunnel endpoint parameters by a cloud service provider infrastructure, according to at least one embodiment.

FIG. 3 illustrates an example method for updating of cloud-side tunnel endpoint parameters by a customer on-premise environment, according to at least one embodiment.

FIG. 4 is a block diagram of a managed communication tunnel environment in which a new on-premise tunnel endpoint is created, according to at least one embodiment.

FIG. 5 illustrates an example method for creating a new on-premise tunnel endpoint, according to at least one embodiment.

FIG. 6 is a block diagram of an exemplary managed communication tunnel environment in which a new cloud-side tunnel endpoint is created, according to at least one embodiment.

FIG. 7 illustrates an example method for creating a new cloud-side tunnel endpoint, according to at least one embodiment.

FIG. 8 is a block diagram of an exemplary managed communication tunnel environment in which a new on-premise tunnel endpoint and a new cloud-side tunnel endpoint are created, according to at least one embodiment.

FIG. 9 illustrates an example method for creating a new cloud-side tunnel endpoint and a new on-premise tunnel endpoint by a cloud service provider infrastructure, according to at least one embodiment.

FIG. 10 illustrates an example method for creating a new cloud-side tunnel endpoint and a new on-premise tunnel endpoint by a customer on-premise environment, according to at least one embodiment.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Many organizations are moving applications and workloads to the cloud. The move enables IT to quickly scale resources based on actual need and provides consolidated management of infrastructure at a global level. An effective way to utilize a cloud service provider's resources is to connect a customer's on-premise environment (such as a datacenter) to the cloud service provider infrastructure. This may be performed by the customer selecting an edge device in their on-premise network and communicating with a router in the cloud environment to establish a communication channel from the edge device to the cloud environment.

The process of establishing the communication channel includes the customer configuring parameters of the communication channel in a manual fashion. The cloud environment typically has no control over the edge device and/or configuration settings associated with establishing the communication channel(s). As such, the process of extending the on-premise network of the customer to the cloud environment is a tedious process involving a high degree of customer intervention.

To address this issue, a cloud service provider infrastructure establishes a communication tunnel between an on-premise tunnel endpoint within a customer on-premise environment and a cloud-side tunnel endpoint within the cloud service provider infrastructure. One or more components of the cloud service provider infrastructure monitor this communication tunnel and determine, based on the monitoring, updates to one or more parameters used to implement the communication tunnel at the on-premise tunnel endpoint within the customer on-premise environment. These updates are sent from the cloud service provider infrastructure to an agent installed within the customer on-premise environment, and the agent implements the updates at the on-premise tunnel endpoint. This enables the automatic updating of the on-premise tunnel endpoint by the cloud service provider infrastructure.

### Updating Tunnel Endpoint Parameters

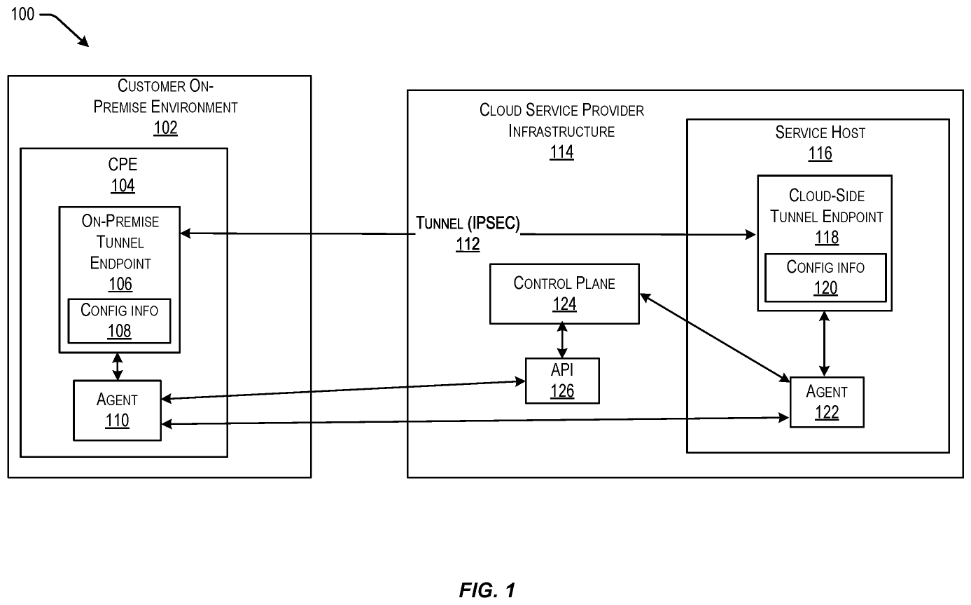

FIG. 1 illustrates an exemplary managed communication tunnel environment 100, according to one exemplary embodiment. As shown, a customer on-premise environment 102 includes customer premise equipment (CPE) 104. Within the CPE 104, an on-premise tunnel endpoint 106 is implemented, where the on-premise tunnel endpoint 106 includes configuration information 108. For example, the CPE 104 may create an internet protocol security (IPSEC) virtual private network (VPN) tunnel that serves as the on-premise tunnel endpoint 106. An agent 110 is also implemented within the CPE 104. In various embodiments, multiple CPEs may be included within the customer on-premise environment 102, multiple on-premise tunnel endpoints may be implemented within each CPE, etc.

Additionally, in various embodiments, the customer on-premise environment 102 may include one or more hardware and/or software computing devices (e.g., servers, computers, virtual hardware devices, etc.). In another embodiment, the CPE 104 may include one or more network communication hardware devices (e.g., network interface cards (NICs), etc.). In yet another embodiment, the agent 110 may include one or more software instances installed within the CPE 104. In another embodiment, the agent 110 may include firmware and or hardware implemented within the CPE 104 (e.g., at the point of manufacture, etc.).

Further, in various embodiments, the on-premise tunnel endpoint 106 may include one end of a communication tunnel 112. For example, the communication tunnel 112 may include a secure connection that allows the transfer of data between the customer on-premise environment 102 and a cloud service provider infrastructure 114, utilizing private network communications, data encapsulation, etc. For instance, the communication tunnel 112 may include an internet protocol security (IPSEC) virtual private network (VPN) tunnel, a secure sockets layer (SSL) tunnel, etc.

Further still, in various embodiments, the configuration information 108 may include information used by the on-premise tunnel endpoint 106 to implement the communication tunnel 112. For example, the configuration information 108 may include routing information such as dynamic routing and/or static routing protocols, one or more private keys used for authentication, border gateway protocol (BGP) and/or internet protocol (IP) address information used by the on-premise tunnel endpoint 106 and/or the cloud-side tunnel endpoint 118, an encryption level and/or type to be implemented via the communication tunnel, a bandwidth to be supported by the communication tunnel 112, etc. In another embodiment, the agent 110 within the CPE 104 may manage the configuration information 108 used by the on-premise tunnel endpoint 106.

Also, the customer on-premise environment 102 includes a cloud service provider infrastructure 114. The cloud service provider infrastructure 114 includes a service host 116, and a cloud-side tunnel endpoint 118 is implemented within the service host 116, where the cloud-side tunnel endpoint 118 includes configuration information 120. An agent 122 is also implemented within the service host 116. A control plane 124 of the cloud service provider infrastructure 114 communicates with the agent 122 of the cloud service provider infrastructure 114, as well as the agent 110 of the customer on-premise environment 102 (via an application program interface (API) 126). The agent 122 of the cloud service provider infrastructure 114 is also in direct communication with the agent 110 of the customer on-premise environment 102 (e.g., via a network connection, etc.).

In addition, in various embodiments, the cloud service provider infrastructure 114 may include a cloud computing environment. In another embodiment, the cloud service provider infrastructure 114 may include a multi-tenant environment (e.g., where the customer on-premise environment 102 is included as a tenant of the cloud service provider infrastructure 114). In another embodiment, the service host 116 of the cloud service provider infrastructure 114 may include a computing device such as a hardware (or virtual) server. For example, multiple service hosts may be implemented within the cloud service provider infrastructure 114.

Furthermore, in various embodiments, the cloud-side tunnel endpoint 118 may include one end of the communication tunnel 112. In another embodiment, the agent 122 within the service host 116 may manage the configuration information 120 used by the cloud-side tunnel endpoint 118, where the configuration information 120 may include information used by the cloud-side tunnel endpoint 118 to implement the communication tunnel 112. The control plane 124 is a component of the cloud service provider infrastructure 114 that manages the creation of tunnels within the cloud service provider infrastructure 114.

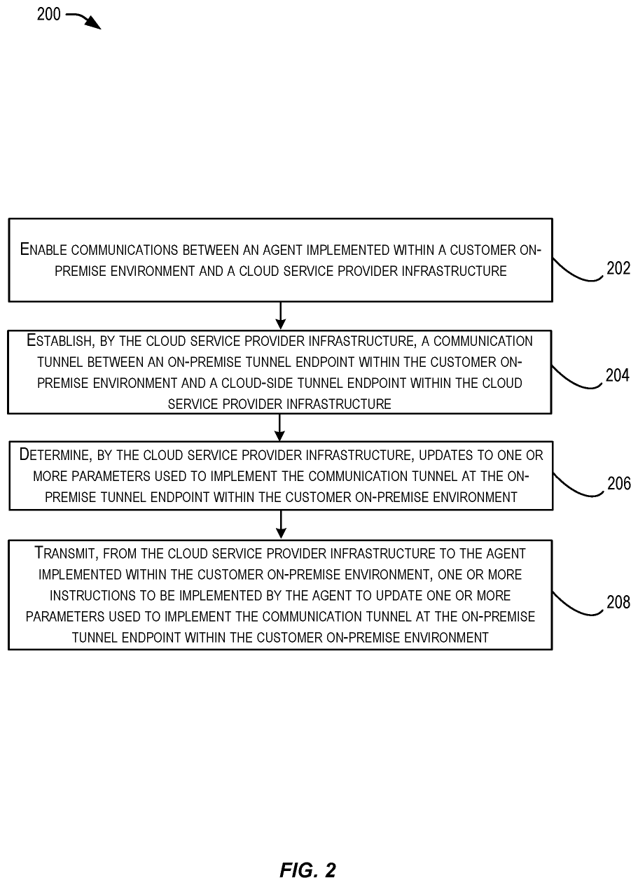

Further still, in various embodiments, one or more components of the cloud service provider infrastructure 114 (such as the agent 122 within the service host 116) may determine updates to the configuration information 108 (e.g., parameters) used to implement the communication tunnel 112 at the on-premise tunnel endpoint 106, and may transmit instructions to be implemented by the agent 110 of the CPE 104 to update the configuration information 108. One exemplary implementation of this is shown in FIG. 2.

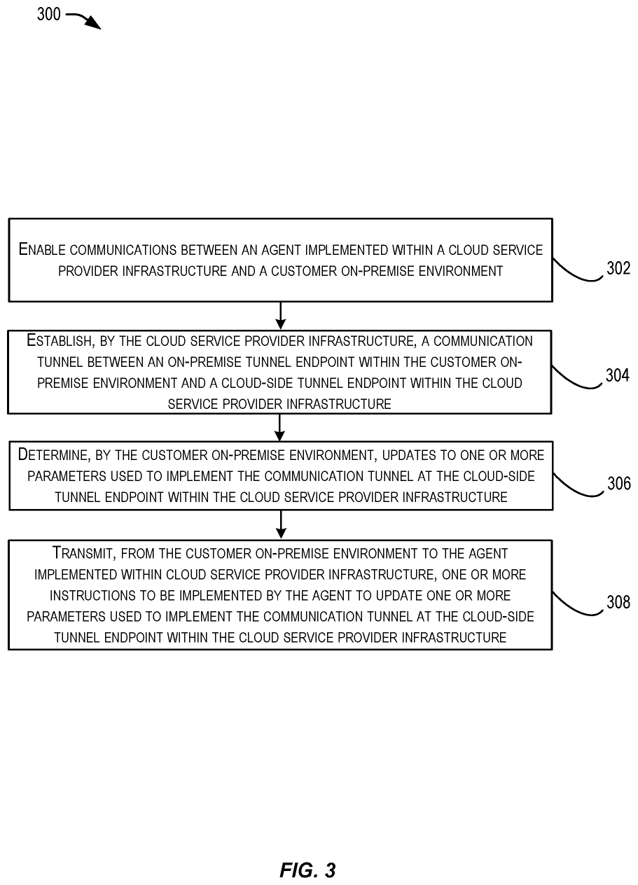

Also, in various embodiments, one or more components of the customer on-premise environment 102 (such as the agent 110 within the CPE 104) may determine updates to the configuration information 120 (e.g., parameters) used to implement the communication tunnel 112 at the cloud-side tunnel endpoint 118, and may transmit instructions to be implemented by the agent 122 of the service host 116 to update the configuration information 120. One exemplary implementation of this is shown in FIG. 3.

FIG. 2 illustrates an example method 200 for updating on-premise tunnel endpoint parameters by a cloud service provider infrastructure, according to at least one embodiment. The method 200 may be performed by one or more components of FIGS. 1, 4, 6, 8, and 11-15. A computer-readable storage medium comprising computer-readable instructions that, upon execution by one or more processors of a computing device, cause the computing device to perform the method 200. The method 200 may performed in any suitable order. It should be appreciated that the method 200 may include a greater number or a lesser number of steps than that depicted in FIG. 2.

The method 200 may begin at 202, where communications are enabled between an agent implemented within a customer on-premise environment and a cloud service provider infrastructure. In various embodiments, the agent implemented within a customer on-premise environment may include one or more software instances installed within the customer on-premise environment. In another embodiment, the agent implemented within a customer on-premise environment may include firmware and or hardware implemented within the customer on-premise environment (e.g., at the point of manufacture, etc.).

Additionally, in various embodiments, the customer on-premise environment may include one or more hardware and/or software computing devices (e.g., servers, computers, virtual hardware devices, etc.). For example, each of the computing devices may include one or more network communication hardware devices (e.g., network interface cards (NICs), etc.).

Further, in various embodiments, the computing devices and/or the network communication hardware devices may be known as customer premise equipment (CPE). In another embodiment, the cloud service provider infrastructure may include a cloud computing environment. In yet another embodiment, the cloud service provider infrastructure may include a multi-tenant environment (e.g., where the customer on-premise environment is included as a tenant of the cloud service provider infrastructure, and the cloud service provider infrastructure provides one or more services (such as computing, storage, and/or networking services) to tenants such as the customer on-premise environment).

Further still, in various embodiments, the communications may be enabled between the agent implemented within the customer on-premise environment and an agent implemented within the cloud service provider infrastructure. For example, the agent implemented within the customer on-premise environment may be installed (e.g., as a container) within a CPE (such as a NIC) of the customer on-premise environment. In another example, the agent implemented within the cloud service provider infrastructure may be installed within a service host of the cloud service provider infrastructure.

Also, in various embodiments, the communications may be enabled between the agent implemented within the customer on-premise environment and a control plane within the cloud service provider infrastructure. For example, the agent implemented within the customer on-premise environment may communicate with the control plane within the cloud service provider infrastructure via an application program interface (API) implemented within the cloud service provider infrastructure.

In addition, at 204, a communication tunnel between an on-premise tunnel endpoint within the customer on-premise environment and a cloud-side tunnel endpoint within the cloud service provider infrastructure is established by the cloud service provider infrastructure. In various embodiments, the on-premise tunnel endpoint may be implemented within a CPE (such as a NIC) of the customer on-premise environment.

Furthermore, in various embodiments, the cloud-side tunnel endpoint may be implemented within a service host (such as a server) of the cloud service provider infrastructure. In another embodiment, the communication tunnel may be implemented utilizing any type of communication tunnel, such as an internet protocol security (IPSEC) virtual private network (VPN) tunnel, a secure sockets layer (SSL) tunnel, etc. In yet another embodiment, the communication tunnel may include a secure connection that allows the transfer of data between the customer on-premise environment and the cloud service provider infrastructure, utilizing private network communications, data encapsulation, etc.

Further still, in various embodiments, the agent implemented within the customer on-premise environment may store and/or manage parameters used to implement the communication tunnel at the on-premise tunnel endpoint. For example, these parameters may include routing information such as dynamic routing and/or static routing protocols, one or more private keys used for authentication, border gateway protocol (BGP) and/or internet protocol (IP) address information, an encryption level to be implemented via the communication tunnel, a bandwidth to be supported by the communication tunnel, etc.

Also, in various embodiments, the agent implemented within the cloud service provider infrastructure may also store and/or manage corresponding parameters used to implement the communication tunnel at the cloud-side tunnel endpoint. For example, these parameters may correspond to the configuration information stored and/or managed by the agent implemented within the customer on-premise environment.

Additionally, in various embodiments, the agent implemented within the cloud service provider infrastructure (and/or the agent implemented within the customer on-premise environment) may monitor a status of the communication tunnel between the customer on-premise environment and the cloud service provider infrastructure. For example, the agent implemented within the cloud service provider infrastructure (and/or the agent implemented within the customer on-premise environment) may monitor characteristics of the communication tunnel (e.g., a security status of the communication tunnel, an availability of one or more security updates to the communication tunnel, a performance of the communication tunnel, etc.).

Further, at 206, the cloud service provider infrastructure determines updates to one or more parameters used to implement the communication tunnel at the on-premise tunnel endpoint within the customer on-premise environment. In various embodiments, the agent implemented within the cloud service provider infrastructure may monitor the communication tunnel. In another embodiment, the updates may include updated routing information, updated private keys, updated border gateway protocol (BGP) and/or internet protocol (IP) address information, an updated encryption level to be implemented via the communication tunnel, an updated bandwidth to be supported by the communication tunnel, etc.

Further still, in various embodiments, the updates to the one or more parameters may be identified within the cloud service provider infrastructure. In another embodiment, the updates may be identified as a result of monitoring performed by the agent implemented within the cloud service provider infrastructure. In yet another embodiment, the agent implemented within the cloud service provider infrastructure may identify one or more parameter updates that implement security updates to the communication tunnel, service upgrades within the communication tunnel, etc. For example, the agent implemented within the cloud service provider infrastructure may be informed (by the agent implemented within the customer on-premise environment and/or another component of the cloud service provider infrastructure) that a bandwidth of the communication tunnel is to be increased or decreased.

Also, in various embodiments, the agent implemented within the cloud service provider infrastructure (and/or the control plane of the cloud service provider infrastructure) may identify one or more parameter updates that avoid one or more failures (e.g., power failures, network failures, hardware failures, etc.). For example, the agent implemented within the cloud service provider infrastructure may anticipate a network failure based on a monitored performance of the communication tunnel, and may determine that an update to the communication tunnel is necessary to avoid the network failure.

In addition, in various embodiments, a request for the updates may be received at the cloud service provider infrastructure from the customer on-premise environment. For example, a user of the customer on-premise environment may request increased bandwidth for the communication tunnel, updated security for the communication tunnel, etc.

Furthermore, at 208, one or more instructions are transmitted from the cloud service provider infrastructure to the agent implemented within the customer on-premise environment, the instructions to be implemented by the agent to update one or more parameters used to implement the communication tunnel at the on-premise tunnel endpoint within the customer on-premise environment. In various embodiments, the one or more instructions may be sent from the agent implemented within the cloud service provider infrastructure to the agent implemented within the customer on-premise environment.

Further still, in various embodiments, the one or more instructions may be sent from the control plane within the cloud service provider infrastructure via an application program interface (API) implemented within the cloud service provider infrastructure to the agent implemented within the customer on-premise environment. In another embodiment, the agent implemented within the customer on-premise environment may receive the instructions and may update one or more parameters used to implement the communication tunnel at the on-premise tunnel endpoint based on the instructions.

Also, in various embodiments, the communication tunnel may be updated, utilizing the updated one or more parameters at the on-premise tunnel endpoint. For example, one or more security settings of the communication tunnel may be updated, a bandwidth of the communication tunnel may be updated, etc.

In this way, a cloud service provider infrastructure may monitor a communication tunnel between the cloud service provider infrastructure and a customer on-premise environment, and the cloud service provider infrastructure may adjust one or more parameters used to implement the communication tunnel at the on-premise tunnel endpoint in response to such monitoring. This may improve a performance and/or security of the communication tunnel, which may in turn improve the functioning of computing hardware implementing the communication tunnel at both the cloud service provider infrastructure and the customer on-premise environment.

FIG. 3 illustrates an example method 300 for updating cloud-side tunnel endpoint parameters by a customer on-premise environment, according to at least one embodiment. The method 300 may be performed by one or more components of FIGS. 1, 4, 6, 8, and 11-15. A computer-readable storage medium comprising computer-readable instructions that, upon execution by one or more processors of a computing device, cause the computing device to perform the method 300. The method 300 may performed in any suitable order. It should be appreciated that the method 300 may include a greater number or a lesser number of steps than that depicted in FIG. 3.

The method 300 may begin at 302, where communications are enabled between an agent implemented within a customer on-premise environment and a cloud service provider infrastructure. See, for example, step 202 of FIG. 2 for an exemplary implementation.

Additionally, at 304, a communication tunnel between an on-premise tunnel endpoint within the customer on-premise environment and a cloud-side tunnel endpoint within the cloud service provider infrastructure is established by the cloud service provider infrastructure. See, for example, step 204 of FIG. 2 for an exemplary implementation.

Further, at 306, the customer on-premise environment determines updates to one or more parameters used to implement the communication tunnel at the cloud-side tunnel endpoint within the cloud service provider infrastructure. In various embodiments, the agent implemented within the customer on-premise environment may monitor the communication tunnel. In another embodiment, the updates may include updated routing information, updated private keys, updated border gateway protocol (BGP) and/or internet protocol (IP) address information, an updated encryption level to be implemented via the communication tunnel, an updated bandwidth to be supported by the communication tunnel, etc.

Further still, in various embodiments, the updates to the one or more parameters may be identified within the customer on-premise environment. In another embodiment, the updates may be identified as a result of monitoring performed by the agent implemented within the customer on-premise environment. In yet another embodiment, the agent implemented within the customer on-premise environment may identify one or more parameter updates that implement security updates to the communication tunnel, service upgrades within the communication tunnel, etc. For example, the agent implemented within the customer on-premise environment may be informed that a bandwidth of the communication tunnel is to be increased or decreased.

Also, in various embodiments, the agent implemented within the customer on-premise environment may identify one or more parameter updates that avoid one or more failures (e.g., power failures, network failures, hardware failures, etc.). For example, the agent implemented within the customer on-premise environment may anticipate a network failure based on a monitored performance of the communication tunnel, and may determine that an update to the communication tunnel is necessary to avoid the network failure.

In addition, in various embodiments, a request for the updates may be received at the customer on-premise environment from a customer. For example, a user of the customer on-premise environment may request increased bandwidth for the communication tunnel, updated security for the communication tunnel, etc.

Furthermore, at 308 one or more instructions are transmitted from the customer on-premise environment to the agent implemented within the cloud service provider infrastructure, the instructions to be implemented by the agent to update one or more parameters used to implement the communication tunnel at the cloud-side tunnel endpoint within the cloud service provider infrastructure.

In various embodiments, the one or more instructions may be sent from the agent implemented within the customer on-premise environment to the agent implemented within the cloud service provider infrastructure. In another embodiment, the one or more instructions may be sent from the cloud service provider infrastructure to the control plane within the cloud service provider infrastructure via an application program interface (API) implemented within the cloud service provider infrastructure.

Further still, in various embodiments, the agent implemented within the cloud service provider infrastructure may receive the instructions and may update one or more parameters used to implement the communication tunnel at the cloud service provider infrastructure based on the instructions. In another embodiment, the communication tunnel may be updated, utilizing the updated one or more parameters at the cloud-side tunnel endpoint. For example, one or more security settings of the communication tunnel may be updated, a bandwidth of the communication tunnel may be updated, etc.

In this way, a customer on-premise environment may monitor a communication tunnel between a cloud service provider infrastructure and the customer on-premise environment, and the customer on-premise environment may adjust one or more parameters used to implement the communication tunnel at the cloud service provider infrastructure in response to such monitoring. This may improve a performance and/or security of the communication tunnel, which may in turn improve the functioning of computing hardware implementing the communication tunnel at both the cloud service provider infrastructure and the customer on-premise environment.

### Creating New Tunnel Endpoints

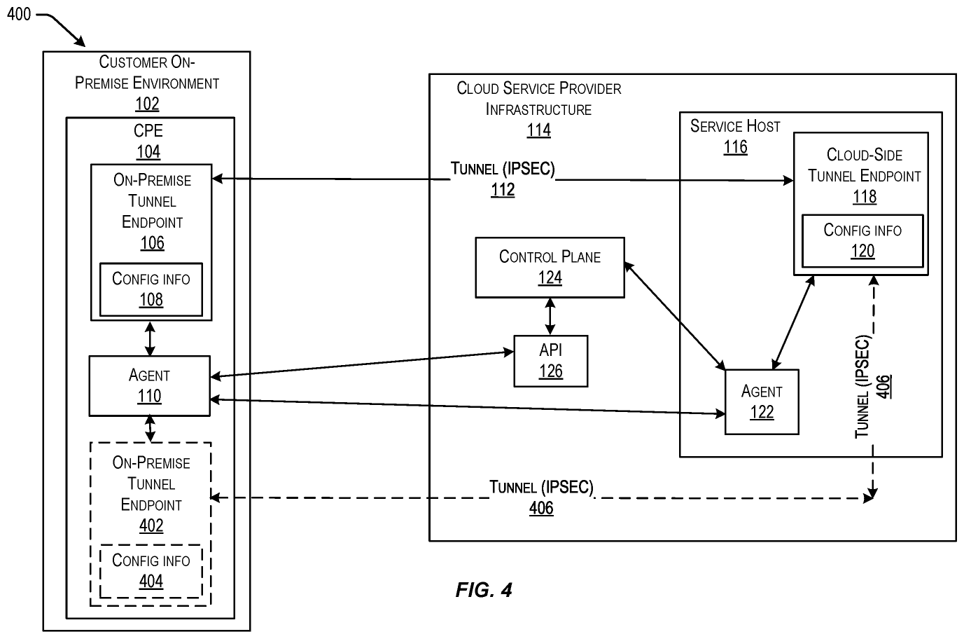

FIG. 4 illustrates an exemplary managed communication tunnel environment 100 in which a new on-premise tunnel endpoint 402 is created, according to one exemplary embodiment. In various embodiments, one or more components of the cloud service provider infrastructure 114 (such as the agent 122 within the service host 116) may determine that a new on-premise tunnel endpoint 402 is to be created within the customer on-premise environment 102.

Additionally, in various embodiments, the agent 122 of the cloud service provider infrastructure 114 may directly transmit to the agent 110 of the customer on-premise environment 102 one or more instructions to be implemented by the agent 110 of the customer on-premise environment 102 to create the new on-premise tunnel endpoint 402. In another embodiment, the agent 122 of the cloud service provider infrastructure 114 may indirectly transmit the instructions to the agent 110 of the customer on-premise environment 102 via the control plane 124 and API 126 of the cloud service provider infrastructure 114.

Further, in various embodiments, in response to receiving the instructions at the agent 110 of the customer on-premise environment 102, the agent 110 may create the new on-premise tunnel endpoint 402 with corresponding configuration information 404. Although the new on-premise tunnel endpoint 402 is shown within the same CPE 104 as the original on-premise tunnel endpoint 106, the new on-premise tunnel endpoint 402 may be created within a different CPE than the current CPE 104 within the customer on-premise environment 102, within a CPE in an on-premise environment different from the current customer on-premise environment 102, etc. A new agent different from the current agent 110 may also be created within the customer on-premise environment 102 and may be associated with the new on-premise tunnel endpoint 402.

Further still, in various embodiments, a new communication tunnel 406 may be established between the new on-premise tunnel endpoint 402 and the existing cloud-side tunnel endpoint 118. In another embodiment, the new communication tunnel 406 may have the same or different settings as the original communication tunnel 112.

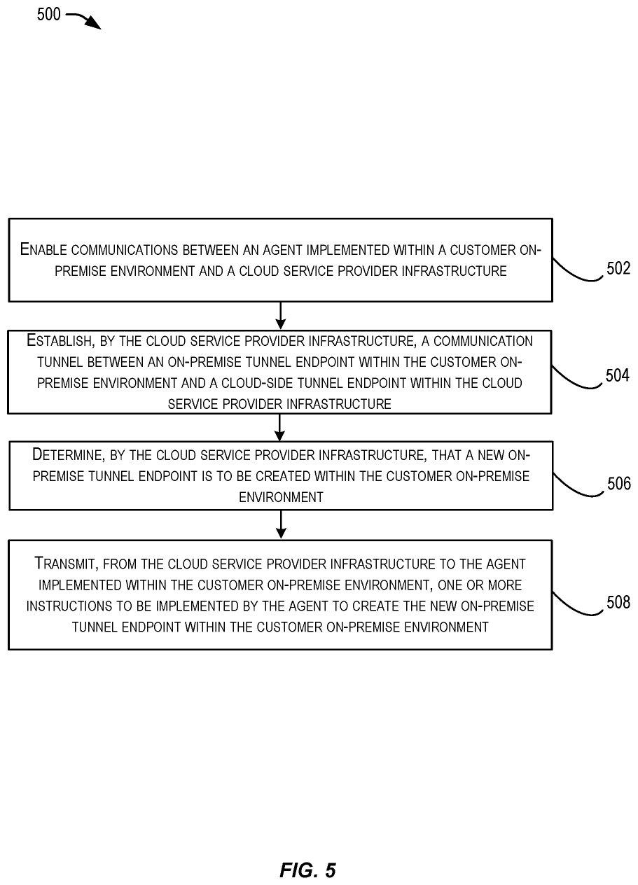

One exemplary implementation of the creation of the new on-premise tunnel endpoint 402 is shown in FIG. 5.

FIG. 5 illustrates an example method 500 for a creating new on-premise tunnel endpoint, according to at least one embodiment. The method 500 may be performed by one or more components of FIGS. 1, 4, 6, 8, and 11-15. A computer-readable storage medium comprising computer-readable instructions that, upon execution by one or more processors of a computing device, cause the computing device to perform the method 500. The method 500 may performed in any suitable order. It should be appreciated that the method 500 may include a greater number or a lesser number of steps than that depicted in FIG. 5.

The method 500 may begin at 502, where communications are enabled between an agent implemented within a customer on-premise environment and a cloud service provider infrastructure. See, for example, step 202 of FIG. 2 for an exemplary implementation.

Additionally, at 504, a communication tunnel between an on-premise tunnel endpoint within the customer on-premise environment and a cloud-side tunnel endpoint within the cloud service provider infrastructure is established by the cloud service provider infrastructure. See, for example, step 204 of FIG. 2 for an exemplary implementation.

Further, at 506, the cloud service provider infrastructure determines that a new on-premise tunnel endpoint is to be created within the customer on-premise environment. In various embodiments, the agent implemented within the cloud service provider infrastructure may monitor the communication tunnel. In another embodiment, the agent implemented within the cloud service provider infrastructure may identify one or more issues with the current on-premise tunnel endpoint within the customer on-premise environment, based on the monitoring. For example, the agent implemented within the cloud service provider infrastructure may identify an amount of dropped packets at the current on-premise tunnel endpoint that exceeds a threshold.

Further still, in various embodiments, the agent implemented within the cloud service provider infrastructure (and/or the control plane of the cloud service provider infrastructure) may identify a failure of the current on-premise tunnel endpoint within the customer on-premise environment, based on the monitoring. In another embodiment, a request for a new on-premise tunnel endpoint may be received at the cloud service provider infrastructure from the customer on-premise environment. For example, a user of the customer on-premise environment may request an updated or new communication tunnel that necessitates a new on-premise tunnel endpoint. In another example, a user of the customer on-premise environment may indicate a failure of the current on-premise tunnel endpoint.

Also, at 508, one or more instructions are transmitted from the cloud service provider infrastructure to the agent implemented within the customer on-premise environment, the instructions to be implemented by the agent to create the new on-premise tunnel endpoint within the customer on-premise environment. In various embodiments, the one or more instructions may be sent from the agent implemented within the cloud service provider infrastructure to the agent implemented within the customer on-premise environment. In another embodiment, the one or more instructions may be sent from the control plane within the cloud service provider infrastructure via an application program interface (API) implemented within the cloud service provider infrastructure to the agent implemented within the customer on-premise environment. The instructions may include configuration information needed to create the new on-premise tunnel endpoint within the customer on-premise environment.

In addition, in various embodiments, the agent implemented within the customer on-premise environment may receive the instructions and may create the new on-premise tunnel endpoint within the customer on-premise environment. For example, the new on-premise tunnel endpoint may be created within the same CPE in which the current on-premise tunnel endpoint is located. In another embodiment, the new on-premise tunnel endpoint may be created within the a different CPE in which the current on-premise tunnel endpoint is located. In yet another embodiment, a new agent may be created in association with the new on-premise tunnel endpoint, where the new agent is separate from the existing agent implemented within the customer on-premise environment.

Furthermore, in various embodiments, the new on-premise tunnel endpoint may communicate with the existing cloud-side tunnel endpoint. For example, this may establish a new communication tunnel separate from the existing communication tunnel. In another example, the existing communication tunnel may be removed when the new communication tunnel is established.

In this way, a cloud service provider infrastructure may monitor a communication tunnel between the cloud service provider infrastructure and a customer on-premise environment, and the cloud service provider infrastructure may implement the creation of a new on-premise tunnel endpoint in response to such monitoring. This may improve a performance and/or security of the communication tunnel, which may in turn improve the functioning of computing hardware implementing the communication tunnel at both the cloud service provider infrastructure and the customer on-premise environment.

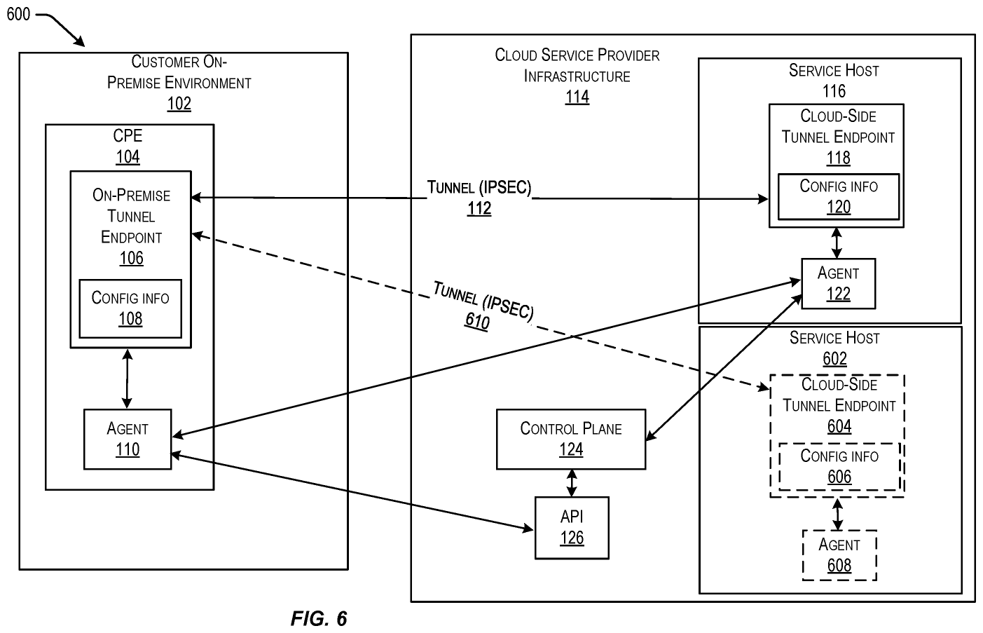

FIG. 6 illustrates an exemplary managed communication tunnel environment 100 in which a new cloud-side tunnel endpoint 604 is created, according to one exemplary embodiment. In various embodiments, one or more components of the customer on-premise environment 102 (such as the agent 110 within the CPE 104) may determine that a new cloud-side tunnel endpoint 604 is to be created within the cloud service provider infrastructure 114.

Additionally, in various embodiments, the agent 110 of the customer on-premise environment 102 may directly transmit to the agent 122 of the cloud service provider infrastructure 114 one or more instructions to be implemented by the agent 122 of the cloud service provider infrastructure 114 to create the new cloud-side tunnel endpoint 604. In another embodiment, the agent 110 of the customer on-premise environment 102 may indirectly transmit the instructions to the agent 122 of the cloud service provider infrastructure 114 via the control plane 124 and API 126 of the cloud service provider infrastructure 114.

Further, in various embodiments, in response to receiving the instructions at the agent 122 of the cloud service provider infrastructure 114, the agent 122 may create the new cloud-side tunnel endpoint 604 with corresponding configuration information 606. Although the new cloud-side tunnel endpoint 604 is shown within a different service host 602 than the original service host 116, the new cloud-side tunnel endpoint 604 may be created within the original service host 116.

Further still, a new agent 608 different from the current agent 122 is also created within the new service host 602 and is associated with the new cloud-side tunnel endpoint 604. In various embodiments, the original agent 122 within the original service host 116 may be associated with the new cloud-side tunnel endpoint 604. In another embodiment, the control plane 124 may create one or more of the new cloud-side tunnel endpoint 604, the configuration information 606, and the new agent 608.

Also, in various embodiments, a new communication tunnel 610 may be established between the new cloud-side tunnel endpoint 604 and the existing on-premise tunnel endpoint 106. In another embodiment, the new communication tunnel 610 may have the same or different settings as the original communication tunnel 112.

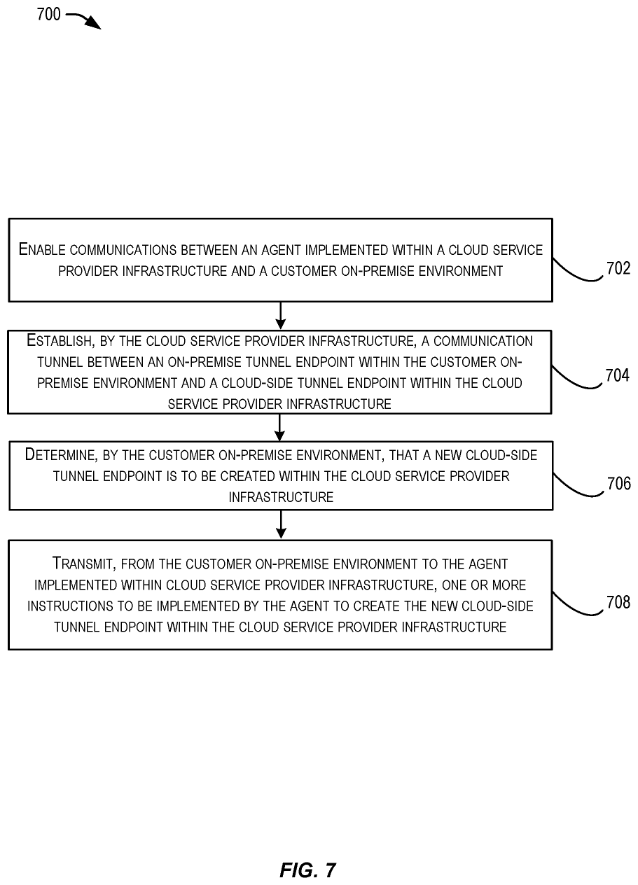

One exemplary implementation of the creation of the new cloud-side tunnel endpoint 604 is shown in FIG. 7.

FIG. 7 illustrates another example method 700 for creating a new cloud-side tunnel endpoint, according to at least one embodiment. The method 700 may be performed by one or more components of FIGS. 1, 4, 6, 8, and 11-15. A computer-readable storage medium comprising computer-readable instructions that, upon execution by one or more processors of a computing device, cause the computing device to perform the method 700. The method 700 may performed in any suitable order. It should be appreciated that the method 700 may include a greater number or a lesser number of steps than that depicted in FIG. 7.

The method 700 may begin at 702, where communications are enabled between an agent implemented within a customer on-premise environment and a cloud service provider infrastructure. See, for example, step 202 of FIG. 2 for an exemplary implementation.

Additionally, at 704, a communication tunnel between an on-premise tunnel endpoint within the customer on-premise environment and a cloud-side tunnel endpoint within the cloud service provider infrastructure is established by the cloud service provider infrastructure. See, for example, step 204 of FIG. 2 for an exemplary implementation.

Further, at 706, it is determined by the customer on-premise environment that a new cloud-side tunnel endpoint is to be created within the cloud service provider infrastructure. In various embodiments, the agent implemented within the customer on-premise environment may monitor the communication tunnel. In another embodiment, the agent implemented within the customer on-premise environment may identify one or more issues with the current cloud-side tunnel endpoint within the cloud service provider infrastructure, based on the monitoring. For example, the agent implemented within the customer on-premise environment may identify an amount of dropped packets at the current cloud-side tunnel endpoint that exceeds a threshold. In yet another embodiment, the agent implemented within the customer on-premise environment may identify a failure of the current cloud-side tunnel endpoint, based on the monitoring.

In another embodiment, the agent implemented within the customer on-premise environment may receive a notification (e.g., from a control plane of the cloud service provider infrastructure) to switch from a failed endpoint within the cloud service provider infrastructure to a new endpoint within the cloud service provider infrastructure, where the notification is received from a control plane of the cloud service provider infrastructure via an application program interface (API) implemented within the cloud service provider infrastructure.

Further still, at 708 one or more instructions are transmitted from the customer on-premise environment to the agent implemented within the cloud service provider infrastructure, the instructions to be implemented by the agent to create the new cloud-side tunnel endpoint within the cloud service provider infrastructure. In various embodiments, the one or more instructions may be sent from the agent implemented within the customer on-premise environment to the agent implemented within the cloud service provider infrastructure. The instructions may include configuration information needed to create the new cloud-side tunnel endpoint within the cloud service provider infrastructure.

Also, in various embodiments, the one or more instructions may be sent from the cloud service provider infrastructure to the control plane within the cloud service provider infrastructure via an application program interface (API) implemented within the cloud service provider infrastructure. In another embodiment, the agent implemented within the cloud service provider infrastructure may receive the instructions and may create the new cloud-side tunnel endpoint within the cloud service provider infrastructure.

For example, the new cloud-side tunnel endpoint may be created within the same service host in which the current cloud-side tunnel endpoint is located. In another example, the new cloud-side tunnel endpoint may be created within a different service host in which the current cloud-side tunnel endpoint is located. In yet another example, a new agent may be created in association with the new cloud-side tunnel endpoint, where the new agent is separate from the existing agent implemented within the cloud service provider infrastructure.

In addition, in various embodiments, the agent implemented within the cloud service provider infrastructure may instruct the control plane to create the new cloud-side tunnel endpoint within the cloud service provider infrastructure. In another embodiment, the new cloud-side tunnel endpoint may communicate with the existing on-premise tunnel endpoint. For example, this may establish a new communication tunnel separate from the existing communication tunnel. In another example, the existing communication tunnel may be removed when the new communication tunnel is established.

In this way, a customer on-premise environment may monitor a communication tunnel between the cloud service provider infrastructure and the customer on-premise environment, and the customer on-premise environment may implement the creation of a new cloud-side tunnel endpoint in response to such monitoring. This may improve a performance and/or security of the communication tunnel, which may in turn improve the functioning of computing hardware implementing the communication tunnel at both the cloud service provider infrastructure and the customer on-premise environment.

Creating a New Tunnel with New Endpoints

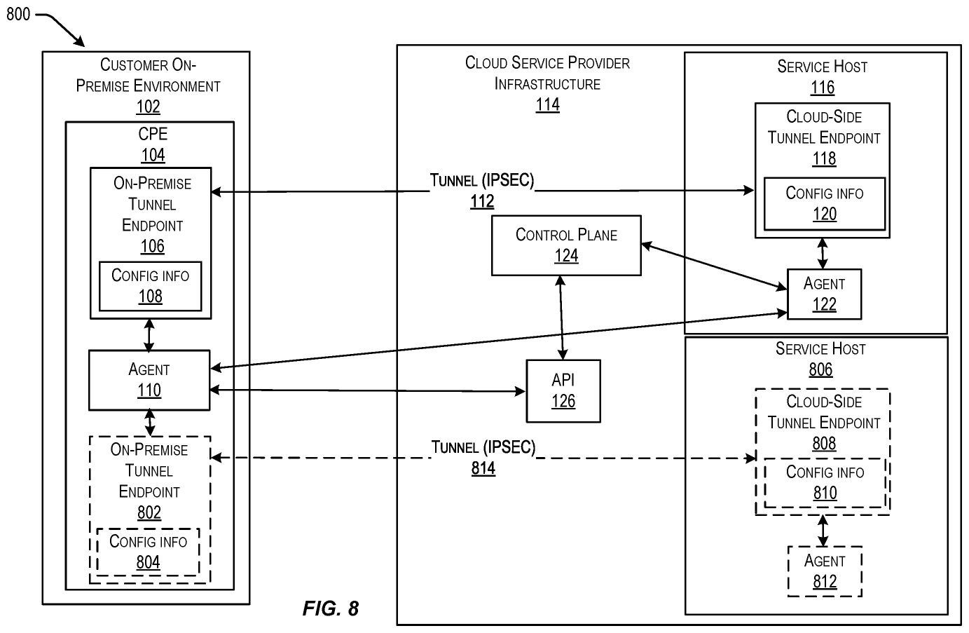

FIG. 8 illustrates an exemplary managed communication tunnel environment 100 in which a new on-premise tunnel endpoint 802 and a new cloud-side tunnel endpoint 808 are created, according to one exemplary embodiment. In various embodiments, one or more components of the cloud service provider infrastructure 114 (such as the agent 122 within the service host 116) may determine that a new on-premise tunnel endpoint 802 is to be created within the customer on-premise environment 102, and a new cloud-side tunnel endpoint 808 is to be created within the cloud service provider infrastructure 114.

Additionally, the agent 122 within the service host 116 may create the new cloud-side tunnel endpoint 808 with corresponding configuration information 810. Although the new cloud-side tunnel endpoint 808 is shown within a different service host 806 than the original service host 116, the new cloud-side tunnel endpoint 808 may be created within the original service host 116.

Further still, a new agent 812 different from the current agent 122 is also created within the new service host 602 and is associated with the new cloud-side tunnel endpoint 808. In various embodiments, the original agent 122 within the original service host 116 may be associated with the new cloud-side tunnel endpoint 604. In another embodiment, the control plane 124 may create one or more of the new cloud-side tunnel endpoint 808, the configuration information 810, and the new agent 812.

Also, in various embodiments, the agent 122 of the cloud service provider infrastructure 114 may directly transmit to the agent 110 of the customer on-premise environment 102 one or more instructions to be implemented by the agent 110 of the customer on-premise environment 102 to create the new on-premise tunnel endpoint 802. In another embodiment, the agent 122 of the cloud service provider infrastructure 114 may indirectly transmit the instructions to the agent 110 of the customer on-premise environment 102 via the control plane 124 and API 126 of the cloud service provider infrastructure 114.

Further, in various embodiments, in response to receiving the instructions at the agent 110 of the customer on-premise environment 102, the agent 110 may create the new on-premise tunnel endpoint 802 with corresponding configuration information 804. Although the new on-premise tunnel endpoint 802 is shown within the same CPE 104 as the original on-premise tunnel endpoint 106, the new on-premise tunnel endpoint 802 may be created within a different CPE than the current CPE 104 within the customer on-premise environment 102, within a CPE in an on-premise environment different from the current customer on-premise environment 102, etc. A new agent different from the current agent 110 may also be created within the customer on-premise environment 102 and may be associated with the new on-premise tunnel endpoint 802.

Also, in various embodiments, one or more components of the customer on-premise environment 102 (such as the agent 110 within the CPE 104) may determine that a new on-premise tunnel endpoint 802 is to be created within the customer on-premise environment 102, and a new cloud-side tunnel endpoint 808 is to be created within the cloud service provider infrastructure 114.

In addition, the agent 110 may create the new on-premise tunnel endpoint 802 with corresponding configuration information 804. Although the new on-premise tunnel endpoint 802 is shown within the same CPE 104 as the original on-premise tunnel endpoint 106, the new on-premise tunnel endpoint 802 may be created within a different CPE than the current CPE 104 within the customer on-premise environment 102, within a CPE in an on-premise environment different from the current customer on-premise environment 102, etc. A new agent different from the current agent 110 may also be created within the customer on-premise environment 102 and may be associated with the new on-premise tunnel endpoint 802.

Additionally, in various embodiments, the agent 110 of the customer on-premise environment 102 may directly transmit to the agent 122 of the cloud service provider infrastructure 114 one or more instructions to be implemented by the agent 122 of the cloud service provider infrastructure 114 to create the new cloud-side tunnel endpoint 808. In another embodiment, the agent 110 of the customer on-premise environment 102 may indirectly transmit the instructions to the agent 122 of the cloud service provider infrastructure 114 via the control plane 124 and API 126 of the cloud service provider infrastructure 114.

Further, in various embodiments, in response to receiving the instructions at the agent 122 of the cloud service provider infrastructure 114, the agent 122 may create the new cloud-side tunnel endpoint 808 with corresponding configuration information 810. Although the new cloud-side tunnel endpoint 808 is shown within a different service host 806 than the original service host 116, the new cloud-side tunnel endpoint 808 may be created within the original service host 116.

Further still, a new agent 812 different from the current agent 122 is also created within the new service host 806 and is associated with the new cloud-side tunnel endpoint 808. In various embodiments, the original agent 122 within the original service host 116 may be associated with the new cloud-side tunnel endpoint 808. In another embodiment, the control plane 124 may create one or more of the new cloud-side tunnel endpoint 808, the configuration information 810, and the new agent 812.

Also, a new communication tunnel 814 is established between the new on-premise tunnel endpoint 802 and the new cloud-side tunnel endpoint 808. In another embodiment, the new communication tunnel 814 may have the same or different settings as the original communication tunnel 112.

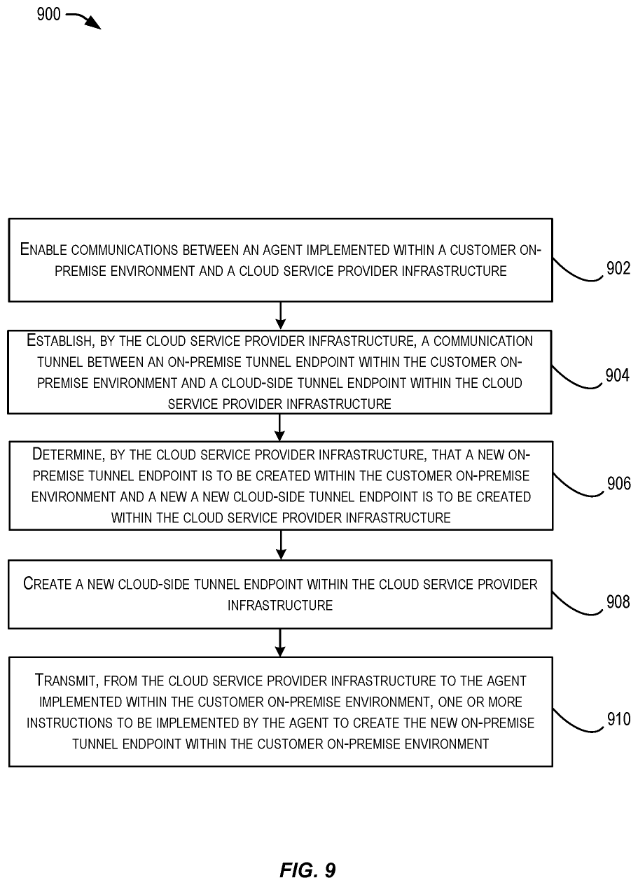

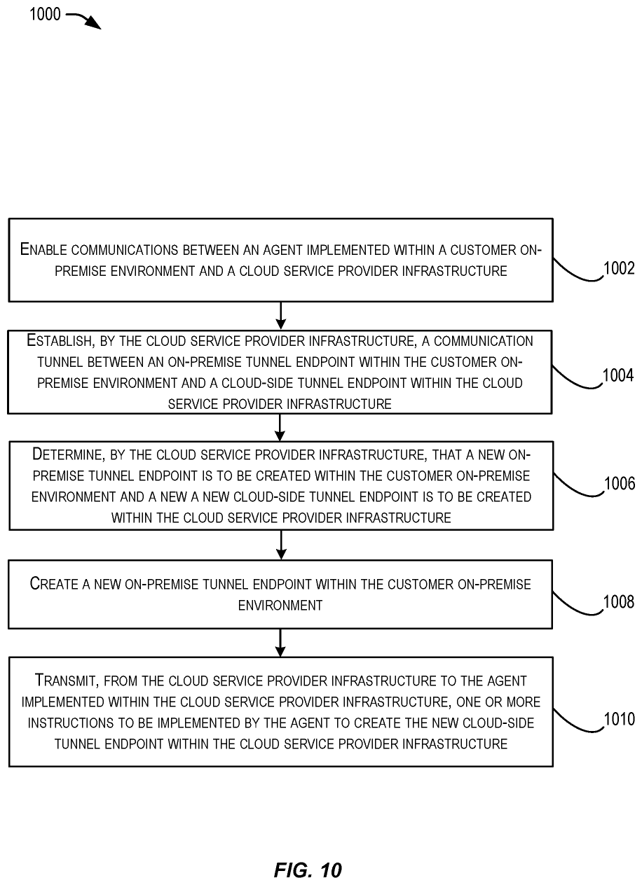

One exemplary implementation by the cloud service provider infrastructure 114 of the creation of the new on-premise tunnel endpoint 802 and the new cloud-side tunnel endpoint 808 is shown in FIG. 9. One exemplary implementation by the customer on-premise environment 102 of the creation of the new on-premise tunnel endpoint 802 and the new cloud-side tunnel endpoint 808 is shown in FIG. 10.

FIG. 9 illustrates an example method 900 for creating a new cloud-side tunnel endpoint and a new on-premise tunnel endpoint by a cloud service provider infrastructure, according to at least one embodiment. The method 900 may be performed by one or more components of FIGS. 1, 4, 6, 8, and 11-15. A computer-readable storage medium comprising computer-readable instructions that, upon execution by one or more processors of a computing device, cause the computing device to perform the method 900. The method 900 may performed in any suitable order. It should be appreciated that the method 900 may include a greater number or a lesser number of steps than that depicted in FIG. 9.

The method 900 may begin at 902, where communications are enabled between an agent implemented within a customer on-premise environment and a cloud service provider infrastructure. See, for example, step 202 of FIG. 2 for an exemplary implementation.

Additionally, at 904, a communication tunnel between an on-premise tunnel endpoint within the customer on-premise environment and a cloud-side tunnel endpoint within the cloud service provider infrastructure is established by the cloud service provider infrastructure. See, for example, step 204 of FIG. 2 for an exemplary implementation.

Further, at 906, the cloud service provider infrastructure determines that a new on-premise tunnel endpoint is to be created within the customer on-premise environment and a new on-premise tunnel endpoint is to be created within the cloud service provider infrastructure. In various embodiments, the agent implemented within the cloud service provider infrastructure may monitor the communication tunnel. In another embodiment, the agent implemented within the cloud service provider infrastructure may identify one or more issues with the current communication tunnel, based on the monitoring. For example, the agent implemented within the cloud service provider infrastructure may identify an amount of dropped packets within the current communication tunnel that exceeds a threshold.

Further still, in various embodiments, the agent implemented within the cloud service provider infrastructure (and/or the control plane of the cloud service provider infrastructure) may identify a failure of the current communication tunnel, based on the monitoring. In another embodiment, a request for a new current communication tunnel may be received at the cloud service provider infrastructure from the customer on-premise environment. For example, a user of the customer on-premise environment may request an updated or new communication tunnel at the customer on-premise environment. This request may include additional parameters such as desired tunnel bandwidth, a key used to communicate with an API of the cloud service provider infrastructure, etc. In another example, a user of the customer on-premise environment may indicate a failure of the current on-premise tunnel endpoint.

Also, at 908, a new cloud-side tunnel endpoint is created within the cloud service provider infrastructure. In various embodiments, the agent implemented within the cloud service provider infrastructure may create the new cloud-side tunnel endpoint within the cloud service provider infrastructure. For example, the new cloud-side tunnel endpoint may be created within the same service host in which the current cloud-side tunnel endpoint is located. In another example, the new cloud-side tunnel endpoint may be created within a different service host in which the current cloud-side tunnel endpoint is located. In yet another example, a new agent may be created in association with the new cloud-side tunnel endpoint, where the new agent is separate from the existing agent implemented within the cloud service provider infrastructure.

In addition, at 910, one or more instructions are transmitted from the cloud service provider infrastructure to the agent implemented within the customer on-premise environment, the instructions to be implemented by the agent to create the new on-premise tunnel endpoint within the customer on-premise environment. In various embodiments, the one or more instructions may be sent from the agent implemented within the cloud service provider infrastructure to the agent implemented within the customer on-premise environment. In another embodiment, the one or more instructions may be sent from the control plane within the cloud service provider infrastructure via an application program interface (API) implemented within the cloud service provider infrastructure to the agent implemented within the customer on-premise environment. The instructions may include configuration information needed to create the new on-premise tunnel endpoint within the customer on-premise environment.

Furthermore, in various embodiments, the agent implemented within the customer on-premise environment may receive the instructions and may create the new on-premise tunnel endpoint within the customer on-premise environment. For example, the new on-premise tunnel endpoint may be created within the same CPE in which the current on-premise tunnel endpoint is located. In another example, the new on-premise tunnel endpoint may be created within the a different CPE in which the current on-premise tunnel endpoint is located. In yet another example, a new agent may be created in association with the new on-premise tunnel endpoint, where the new agent is separate from the existing agent implemented within the customer on-premise environment.

Further still, in various embodiments, the new on-premise tunnel endpoint may communicate with the new cloud-side tunnel endpoint. For example, this may establish a new communication tunnel separate from the existing communication tunnel. In another example, the existing communication tunnel may be removed when the new communication tunnel is established.

In this way, a cloud service provider infrastructure may monitor a communication tunnel between the cloud service provider infrastructure and a customer on-premise environment, and the cloud service provider infrastructure may implement the creation of a new communication tunnel with a new cloud-side tunnel endpoint and a new on-premise tunnel endpoint in response to such monitoring. This may improve a performance and/or security of the communication tunnel, which may in turn improve the functioning of computing hardware implementing the communication tunnel at both the cloud service provider infrastructure and the customer on-premise environment.

FIG. 10 illustrates an example method 1000 for creating a new cloud-side tunnel endpoint and a new on-premise tunnel endpoint by a cloud service provider infrastructure, according to at least one embodiment. The method 1000 may be performed by one or more components of FIGS. 1, 4, 6, 8, and 11-15. A computer-readable storage medium comprising computer-readable instructions that, upon execution by one or more processors of a computing device, cause the computing device to perform the method 1000. The method 1000 may performed in any suitable order. It should be appreciated that the method 1000 may include a greater number or a lesser number of steps than that depicted in FIG. 10.

The method 1000 may begin at 1002, where communications are enabled between an agent implemented within a customer on-premise environment and a cloud service provider infrastructure. See, for example, step 202 of FIG. 2 for an exemplary implementation.

Additionally, at 1004, a communication tunnel between an on-premise tunnel endpoint within the customer on-premise environment and a cloud-side tunnel endpoint within the cloud service provider infrastructure is established by the cloud service provider infrastructure. See, for example, step 204 of FIG. 2 for an exemplary implementation.

Further, at 1006, it is determined by the customer on-premise environment that a new on-premise tunnel endpoint is to be created within the customer on-premise environment and a new on-premise tunnel endpoint is to be created within the cloud service provider infrastructure. In various embodiments, the agent implemented within the customer on-premise environment may monitor the communication tunnel.

Further still, in various embodiments, the agent implemented within the customer on-premise environment may identify one or more issues with the current communication tunnel, based on the monitoring. For example, the agent implemented within the customer on-premise environment may identify an amount of dropped packets within the current communication tunnel that exceeds a threshold. In another embodiment, the agent implemented within the customer on-premise environment may identify a failure of the current communication tunnel, based on the monitoring. In yet another embodiment, the agent implemented within the customer on-premise environment may identify a request from a user for a new communication tunnel.

Also, at 1008, a new on-premise tunnel endpoint is created within the customer on-premise environment. In various embodiments, the agent implemented within the customer on-premise environment may create the new on-premise tunnel endpoint within the customer on-premise environment. For example, the new on-premise tunnel endpoint may be created within the same CPE in which the current on-premise tunnel endpoint is located. In another example, the new on-premise tunnel endpoint may be created within the a different CPE in which the current on-premise tunnel endpoint is located. In yet another example, a new agent may be created in association with the new on-premise tunnel endpoint, where the new agent is separate from the existing agent implemented within the customer on-premise environment.

In addition, at 1010, one or more instructions are transmitted from the customer on-premise environment to the agent implemented within the cloud service provider infrastructure, the instructions to be implemented by the agent to create the new cloud-side tunnel endpoint within the cloud service provider infrastructure. In various embodiments, the one or more instructions may be sent from the agent implemented within the customer on-premise environment to the agent implemented within the cloud service provider infrastructure. In another embodiment, the one or more instructions may be sent from the cloud service provider infrastructure to the control plane within the cloud service provider infrastructure via an application program interface (API) implemented within the cloud service provider infrastructure. The instructions may include configuration information needed to create the new cloud-side tunnel endpoint within the cloud service provider infrastructure.

Furthermore, in various embodiments, the agent implemented within the cloud service provider infrastructure may receive the instructions and may create the new cloud-side tunnel endpoint within the cloud service provider infrastructure. For example, the new cloud-side tunnel endpoint may be created within the same service host in which the current cloud-side tunnel endpoint is located. In another example, the new cloud-side tunnel endpoint may be created within a different service host in which the current cloud-side tunnel endpoint is located.

In yet another example, a new agent may be created in association with the new cloud-side tunnel endpoint, where the new agent is separate from the existing agent implemented within the cloud service provider infrastructure.

Further still, in various embodiments, the agent implemented within the cloud service provider infrastructure may instruct the control plane to create the new cloud-side tunnel endpoint within the cloud service provider infrastructure. In another embodiment, the new cloud-side tunnel endpoint may communicate with the new on-premise tunnel endpoint. For example, this may establish a new communication tunnel separate from the existing communication tunnel. In another example, the existing communication tunnel may be removed when the new communication tunnel is established.

In this way, a customer on-premise environment may monitor a communication tunnel between a cloud service provider infrastructure and the customer on-premise environment, and the customer on-premise environment may implement the creation of a new communication tunnel with a new cloud-side tunnel endpoint and a new on-premise tunnel endpoint in response to such monitoring. This may improve a performance and/or security of the communication tunnel, which may in turn improve the functioning of computing hardware implementing the communication tunnel at both the cloud service provider infrastructure and the customer on-premise environment.

### High Speed Managed Encrypted Cloud Connection

Tenants of a cloud provider may want to connect their local on-premise network to the cloud, or some other remote site. Some tenants want high bandwidth connections, and tenants may want their connections to be resilient to both planned and unplanned events. Tenant may not want to micromanage the connections.

In various embodiments, a tenant creates a virtual encrypted gateway in cloud provider console (or an API, a software development kit (SDK), etc.). This generates a unique ID for the gateway. The tenant selects some number of on-premise hosts they want to use to connect to the cloud (these hosts are referred to as “customer premise equipment” or CPE).

For each CPE, the tenant may use a cloud provider console and may adds information for that CPE to the console. The tenant creates an encrypted public/private key pair to use for CPE authorization to cloud APIs. The tenant may download a container and may set up configuration information for the container. This configuration information may include a path to a private key for authentication, identifiers for any gateways the container makes connections to, etc.

The configuration information may also include routing information and may support both dynamic routing protocols as well as static routing. This configuration information may be stored by a cloud provider and may be pulled from the cloud instead of being stored locally.

In various embodiments, when the container is run, it calls out to the cloud provider API. The container gets configuration info on how to set up encrypted connections to the cloud provider. For example, SSL or IPSec or other encryption technology may be used. This setup may be transparent to the tenant.

Additionally, the container and cloud provider work together to check the health of each encrypted link. For example, the container may tell the cloud provider which on-premise routes are accessible though the container, and the cloud provider may tell the container which cloud networks are available through the gateway. The container may run a routing protocol back to an on-premise router and may announce the cloud provider routing information.

Further, if the customer set up multiple CPEs, the cloud provider and container may work together to figure out which CPE to send traffic back to the on-premise network (and which tunnels connect to that CPE). The tenant routers may send traffic to the tenant server running the container, as per the routing information. The container service code may periodically call back to the cloud provider to see if it needs to make any operation changes.

From the tenant point of view, one or multiple CPEs are set up and once they are running, there is an expectation for automatically implemented high bandwidth and high reliability. Multiple tunnels/connections per CPE to cloud provider allow for higher throughput, as bandwidth may be gated on a per-CPU core basis. Multiple tunnels may spread the load out per flow across all the connections. If needed, the CPE and cloud provider may set up additional tunnels to other hosts to get more potential bandwidth. This may be driven by either the CPE or the cloud provider and may occur without required tenant input/changes.

On the cloud provider side, cloud providers may need to implement security patching on hosts, as well as service upgrades, new feature additions, and bug fixes. Previously, these activities may require interrupting tenant connections. However, the cloud provider may now schedule a cloud host reboot. All the tenant CPEs that have tunnels to that host may automatically establish new tunnels to another host, shift/drain traffic, and then take down the tunnel. When all the connections are drained off the cloud provider service host, the planned maintenance may start. Once the host was back in service, the cloud provider could use test CPEs to validate that the data plane host worked. Once all the tests pass, the host may be available for CPEs to be told it was available for new tunnels.

In various embodiments, the cloud provider, anticipating power, hardware, network failures, may ensure that the tunnels from the CPE to the cloud landed on cloud hosts in different fault domains. If there was an event that impacted a cloud service host or data center, there may already be tunnels between all the CPEs and multiple cloud fault domains, so that any one fault domain failure still leaves working tunnels.

There may also be failures on the tenant side with their CPEs. These should be detected by the container service software and cloud provider. Both the CPE and cloud provider may be constantly looking for failure conditions. When they are detected, the cloud provider service and container service code may both react. The cloud provider may tell the CPE service code to bring up new tunnels to other hosts. The CPE may be told to have a set of connections running in the background, but not to use them unless there is a failure. All the logic behind this may be driven by the cloud provider, allowing them to determine the placement of CPE to cloud tunnels.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

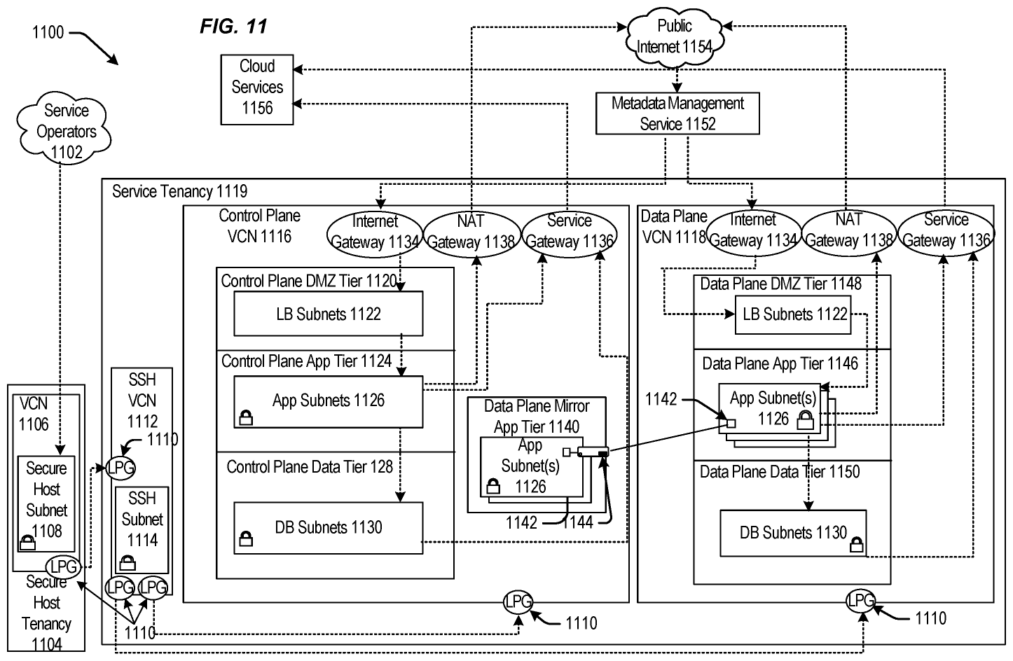

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively couple to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

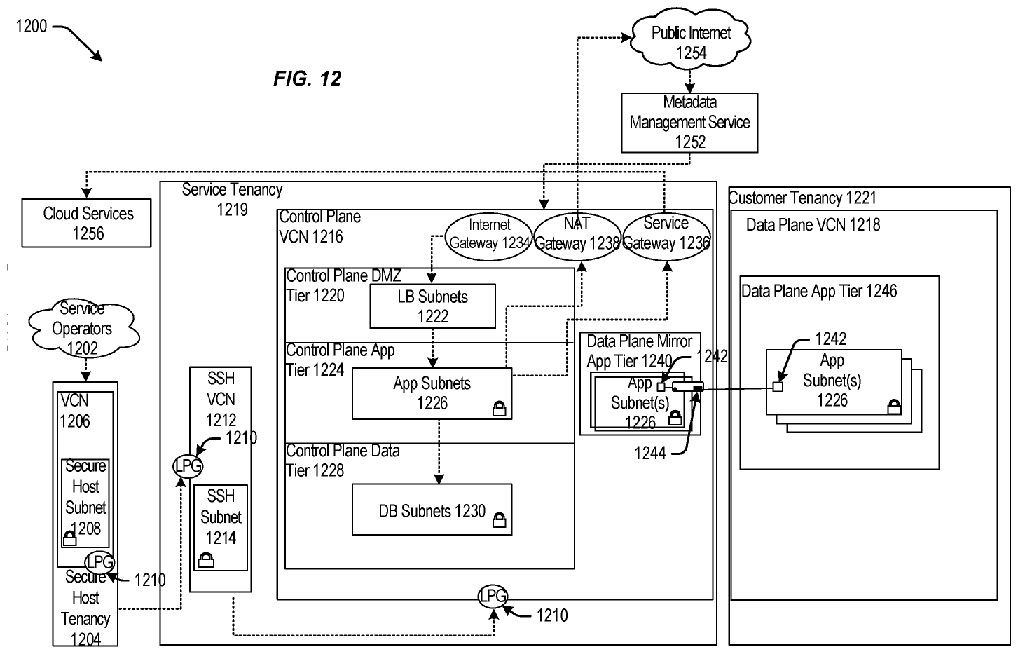

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively couple to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may beisolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

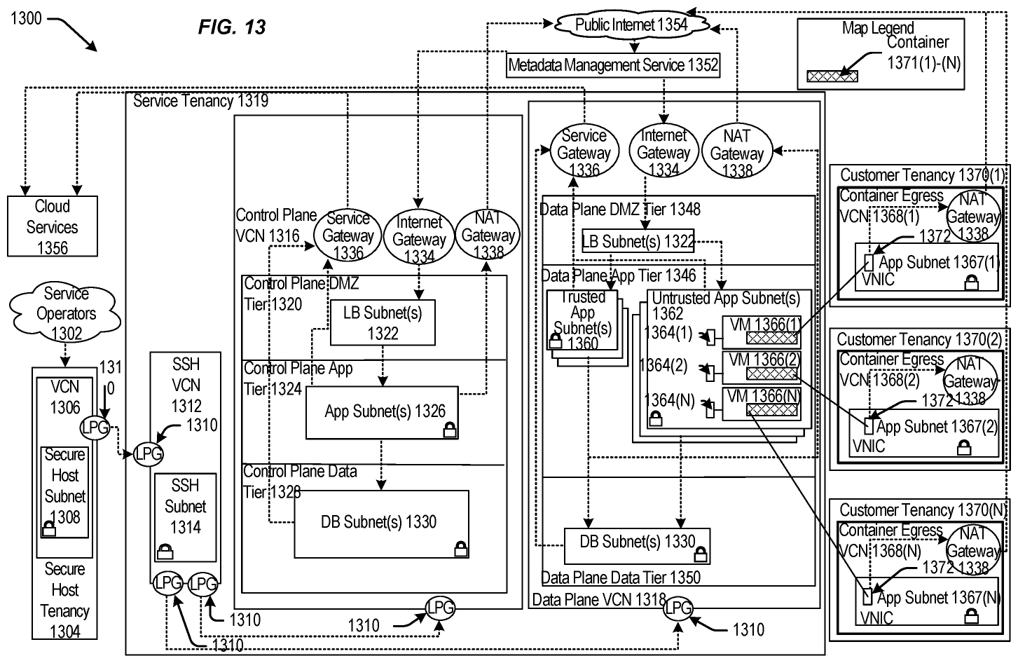

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 13 16 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

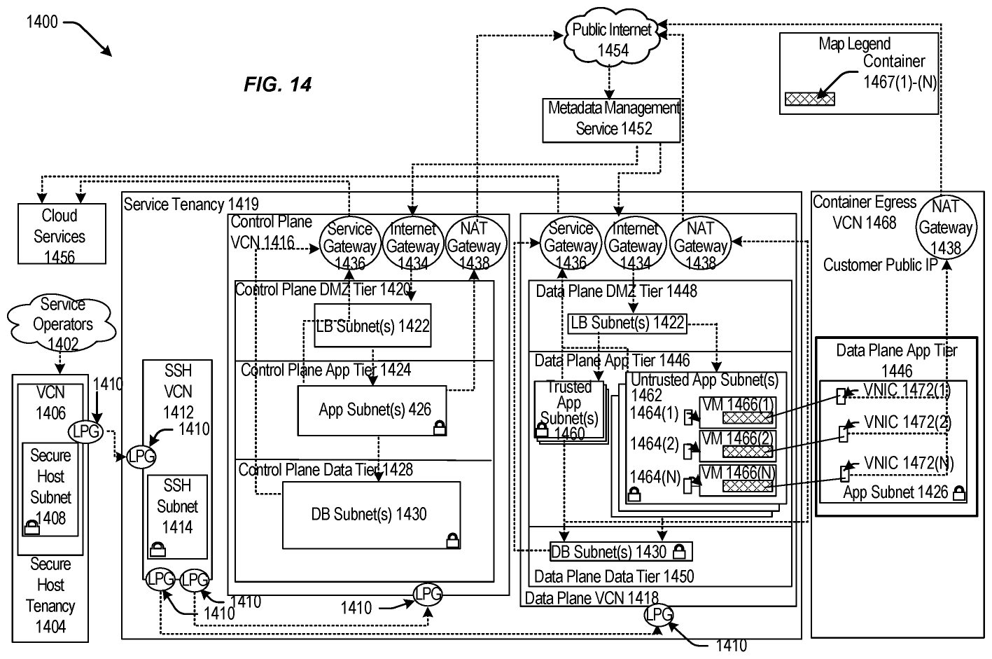

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

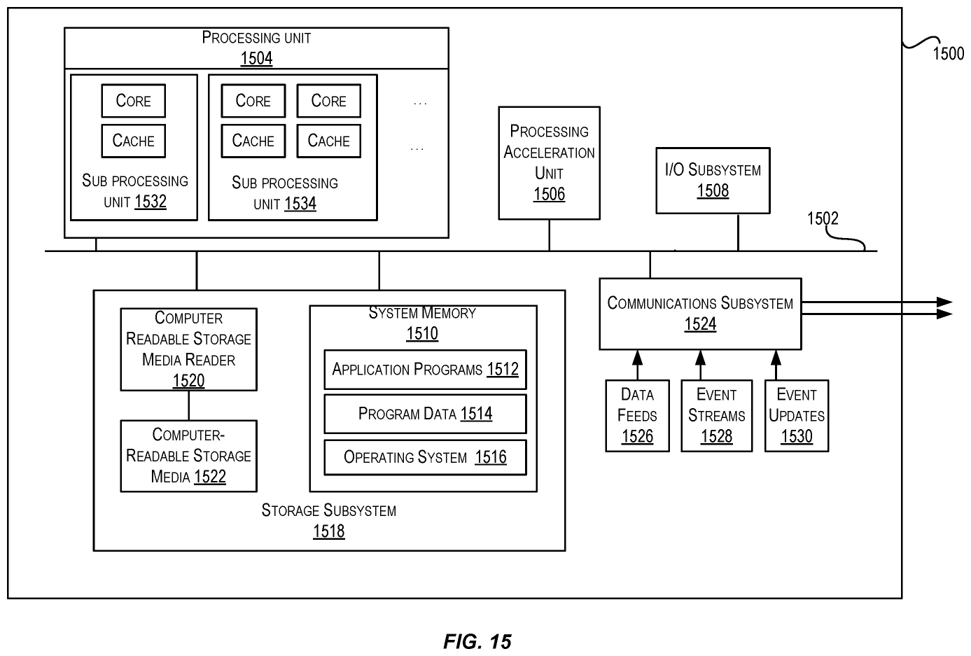

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
monitoring, by a computer system within a cloud service provider infrastructure, a communication tunnel established between an on-premise tunnel endpoint within a customer on-premise environment and a cloud-side tunnel endpoint within the cloud service provider infrastructure;
determining, by the computer system within the cloud service provider infrastructure, updates to one or more parameters used by the on-premise tunnel endpoint to implement the communication tunnel; and
transmitting, by the computer system within the cloud service provider infrastructure to an agent implemented within the customer on-premise environment, one or more instructions to be implemented by the agent to update the one or more parameters used by the on-premise tunnel endpoint to implement the communication tunnel.

2. The computer-implemented method of claim 1, comprising enabling, by the computer system within the cloud service provider infrastructure, communications between the agent implemented within the customer on-premise environment and the cloud service provider infrastructure.

3. The computer-implemented method of claim 1, wherein the agent implemented within the customer on-premise environment includes one or more software instances installed within the customer on-premise environment.

4. The computer-implemented method of claim 1, wherein the agent implemented within the customer on-premise environment includes hardware implemented within the customer on-premise environment at a point of manufacture.

5. The computer-implemented method of claim 1, comprising establishing, by the computer system within the cloud service provider infrastructure, the communication tunnel between the on-premise tunnel endpoint within the customer on-premise environment and a cloud-side tunnel endpoint within the cloud service provider infrastructure.

6. The computer-implemented method of claim 1, wherein the on-premise tunnel endpoint is implemented within a network interface card (NIC) of the customer on-premise environment.

7. The computer-implemented method of claim 3, wherein the communication tunnel includes an internet protocol security (IPSEC) virtual private network (VPN) tunnel.

8. The computer-implemented method of claim 1, wherein the one or more parameters include routing information, one or more keys used for authentication, an encryption level to be implemented via the communication tunnel, and a bandwidth to be supported by the communication tunnel.

9. The computer-implemented method of claim 1, wherein the one or more instructions are sent from an agent implemented within the cloud service provider infrastructure directly to the agent implemented within the customer on-premise environment.

10. The computer-implemented method of claim 1, wherein the one or more instructions are sent from a control plane within the cloud service provider infrastructure via an application program interface (API) implemented within the cloud service provider infrastructure to the agent implemented within the customer on-premise environment.

11. A system comprising:
one or more processors configured to:
monitor a communication tunnel established between an on-premise tunnel endpoint within a customer on-premise environment and a cloud-side tunnel endpoint within a cloud service provider infrastructure;
determine updates to one or more parameters used by the on-premise tunnel endpoint to implement the communication tunnel; and
transmit, to an agent implemented within the customer on-premise environment, one or more instructions to be implemented by the agent to update the one or more parameters used by the on-premise tunnel endpoint to implement the communication tunnel.

12. The system of claim 11, wherein the one or more processors are further configured to enable, within the cloud service provider infrastructure, communications between the agent implemented within the customer on-premise environment and the cloud service provider infrastructure.

13. The system of claim 11, wherein the agent implemented within the customer on-premise environment includes one or more software instances installed within the customer on-premise environment.

14. The system of claim 11, wherein the agent implemented within the customer on-premise environment includes hardware implemented within the customer on-premise 2 environment at a point of manufacture.

15. The system of claim 11, wherein the one or more processors are further configured to establish, within the cloud service provider infrastructure, the communication tunnel between the on-premise tunnel endpoint within the customer on-premise environment and a cloud-side tunnel endpoint within the cloud service provider infrastructure.

16. The system of claim 11, wherein the on-premise tunnel endpoint is implemented within a network interface card (NIC) of the customer on-premise environment.

17. The system of claim 11, wherein the communication tunnel includes an internet protocol security (IPSEC) virtual private network (VPN) tunnel.

18. The system of claim 11, wherein the one or more parameters include routing information, one or more keys used for authentication, an encryption level to be implemented via the communication tunnel, and a bandwidth to be supported by the communication tunnel.

19. The system of claim 11, wherein the one or more instructions are sent from an agent implemented within the cloud service provider infrastructure directly to the agent implemented within the customer on-premise environment.

20. A non-transitory computer-readable medium storing a set of instructions, the set of instructions when executed by one or more processors cause processing to be performed comprising:
monitoring, by a computer system within a cloud service provider infrastructure, a communication tunnel established between an on-premise tunnel endpoint within a customer on-premise environment and a cloud-side tunnel endpoint within the cloud service provider infrastructure;
determining, by the computer system within the cloud service provider infrastructure, updates to one or more parameters used by the on-premise tunnel endpoint to implement the communication tunnel; and
transmitting, by the computer system within the cloud service provider infrastructure to an agent implemented within the customer on-premise environment, one or more instructions to be implemented by the agent to update the one or more parameters used by the on-premise tunnel endpoint to implement the communication tunnel.
